(19) United States
(12) Patent Application Publication
(10) Pub. No.: US 2026/0366656 A1
(43) Pub. Date: Nov. 19, 2026

(54) Detachable Connector Assembly

(71) Applicant: Illinois Tool Works Inc., Glenview, IL (US)

(72) Inventor: Cong Cao, Shanghai (CN)

(21) Appl. No.: 19/676,680

(22) Filed: May 13, 2026

(30) Foreign Application Priority Data
May 14, 2025 (CN) 202510621837.6

(51) Int. Cl. F16L 15/00; F16L 15/06

(52) U.S. Cl. CPC F16L 15/008; F16L 15/06

(57) ABSTRACT

A connector assembly comprises a female connector and a male connector, both having hollow structures. The female connector includes a ring and a plurality of resilient jaws extending axially from the ring and distributed circumferentially therearound. Each resilient jaw includes internal threads on an inner surface. The male connector includes external threads configured for threaded engagement with the internal threads of the resilient jaws. Each resilient jaw terminates in a supporting portion at its free end, wherein an inner peripheral surface of the supporting portion protrudes radially inward beyond the internal threads to provide guided alignment and support during threaded engagement between the female and male connectors.

### RELATED APPLICATIONS

The present application claims the benefit of Chinese Patent Application No. 202510621837.6, filed May 14, 2025, titled “Detachable Connector Assembly,” the contents of which are hereby incorporated by reference.

### BACKGROUND

The present disclosure relates to the field of a connector technology and more particularly relates to a detachable connector assembly.

A pass-through joint, also known as a bulkhead connector assembly, is a connecting device used to enable fluid transfer, electrical transmission, or signal transmission. The connector assembly is commonly used in sheet metal parts or other thin plate structures in equipment such as automotive vehicles. This type of connector assembly is typically mounted on a sheet metal part to facilitate convenient passing through the sheet metal or thin plate for connection. The connector assembly generally comprises a female connector and a male connector.

In existing designs, the female connector and the male connector are typically in a firmly engaged state after final assembly. Once assembled in this manner, it is difficult to separate them without causing damage to the assembly. Therefore, when maintenance or inspection of the connector assembly is required, such as in situations where the connector assembly must be removed from a sheet metal part or thin plate, disassembly is often only possible by destructive disassembly. This approach not only damages the connector assembly itself, but also may further cause damage to accessory pipelines or related components, thereby necessitating replacement with a new connector assembly upon reinstallation. As a result, maintenance costs are significantly increased and maintenance efficiency is reduced.

Therefore, there needs in the art a detachable connector assembly which should enable repeated mounting and convenient dismounting between the female connector and the male connector. Ideally, the connector assembly should allow quick separation without the need for tools, allowing it to be smoothly removed from and reinstalled on a sheet metal part or thin plate without causing structural damage. Such a design not only can effectively reduce maintenance and replacement costs, but also significantly improve ease usage and overall production efficiency, thereby meeting modern industrial demands for highly reliable and maintainable connection systems.

### SUMMARY

The present disclosure relates generally to a detachable connector assembly, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a perspective view of a detachable connector assembly according to one embodiment of the present disclosure, wherein the connector assembly is in a pre-mounting state.

FIG. 2 is an exploded perspective view of a detachable connector assembly according to one embodiment of the present disclosure.

FIG. 3a is a perspective view of a female connector of a detachable connector assembly according to one embodiment of the present disclosure.

FIG. 3b is a cross-sectional view of the female connector of the detachable connector assembly according to one embodiment of the disclosure as shown in FIG. 3a, with the geometry of the threads being illustrated in an enlarged manner.

FIG. 4 is a perspective view of a male connector of a detachable connector assembly according to one embodiment of the present disclosure.

FIG. 5 is a cross-sectional view of the detachable connector assembly according to one embodiment of the present disclosure as shown in FIG. 1, wherein the connector assembly is in a pre-mounting state.

FIG. 6 is a cut-away perspective view of the detachable connector assembly in accordance with one embodiment of the present disclosure as shown in FIG. 1, wherein the connector assembly is in a pre-mounting state.

FIG. 7 is a perspective view of a detachable connector assembly according to another embodiment of the present disclosure, wherein the connector assembly is in a mounted state.

FIG. 8 is a cross-sectional view of a detachable connector assembly according to another embodiment of the present disclosure, wherein the connector assembly is in a mounted state.

FIG. 9 is a schematic cross-sectional view of a detachable connector assembly according to yet another embodiment of the present disclosure, wherein the connector assembly is in a mounted state and the connector assembly includes an elastomeric ring.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

In order to overcome the problem that the connector assembly in the prior art is not able to be repeatedly mounted and dismounted, the disclosure provides a connector assembly which has a simple structure and is convenient to use and can be repeatedly mounted and dismounted.

According to an aspect of the present disclosure, there is provided a connector assembly, wherein the connector assembly comprises a female connector and a male connector, and the female connector and the male connector are both of a hollow structure, and the female connector comprises a ring and resilient jaws extending from the ring in the axial direction, and the resilient jaws are distributed on the ring in the circumferential direction, and internal threads are arranged on the resilient jaws, and the male connector is provided with external threads for threaded engagement with the internal threads, and the resilient jaws have supporting portions at free ends, and the inner peripheral sides of the supporting portions protrude further radially inwards than the internal threads.

In one embodiment of the connector assembly according to the disclosure, the female connector is an one-piece structure which is integrally formed, and the female connector has a central axis X, and the male connector is movable by rotation relative to the female connector between a pre-mounting state, in which the internal threads are at least partially engaged with the external threads, and a mounted state, in which the resilient jaws are spread radially outwards at the supporting portions by the external threads.

In one embodiment of the connector assembly according to the disclosure, the female connector has the internal thread with a triangular cross-section, and the bottom surface of the internal thread forms an angle b with the central axis X, the angle b being between about 90 and 105 degrees, preferably about 90 degrees, and the slope of the internal thread forms an angle a with the central axis X, the angle a being less than 30 degrees, preferably between 15 and 25 degrees.

In one embodiment of the connector assembly according to the disclosure, the resilient jaws are evenly distributed in a circumferential direction; or the female connector comprises an even number of resilient jaws arranged diametrically opposite on the ring.

In one embodiment of the connector assembly according to the disclosure, the internal threads of the female connector are located on the inner circumferential surface of the resilient jaws, and the female connector comprises at least two turns and preferably three turns of the internal threads, and the number of turns of the external threads is at least one turn greater than the number of turns of the internal threads, and preferably two or three more turns greater than the number of turns of the internal threads.

In one embodiment of the connector assembly according to the disclosure, the resilient jaws are integrally formed with the ring at one end, and the inner circumferential surfaces of the resilient jaws are continuous from an inner circumferential surface of the ring, and the outer circumferential surfaces of the resilient jaws are located radially inward of the outer circumferential surface of the ring.

In one embodiment of the connector assembly according to the disclosure, each resilient jaws has supporting portions at free end thereof, and the supporting portions have an axial length which is greater than the axial length of one thread groove of the external threads, and the inner peripheral side of the supporting portions protrudes radially inwards further towards the central axis X than the internal threads.

In one embodiment of the connector assembly according to the disclosure, the male connector is an one-piece structure which is integrally formed, and the male connector has a central axis Y, the central axis X of the female connector coinciding with the central axis Y of the male connector when the female connector is connected to the male connector, and two ends of the male connector are each provided with a pipe connection portion respectively, and the male connector comprises an internal passage, and the internal passage extends axially through the pipe connection portions.

In one embodiment of the connector assembly according to the disclosure, at a position near a front end of the external thread of the male connector, a supporting portion receiving groove is provided for receiving the supporting portion of the female connector, and the supporting portion receiving groove is recessed deeper than the external threads, and the supporting portions are able to be received in the supporting portion receiving groove when the female connector is pre-mounted on the male connector in a pre-mounting state, and the supporting portions are spread radially outward by the external threads when in a mounted state.

In one embodiment of the connector assembly according to the disclosure, the male connector is provided with a first annular projection in front of the supporting portion receiving groove, and foremost ends of the supporting portions of the resilient jaws substantially contact the first annular projection when the female connector is pre-mounted on the male connector in a pre-mounting state, so that the male connector can no longer be axially moved forward by being rotated or pushed relative to the female connector.

In one embodiment of the connector assembly according to the disclosure, the male connector is provided with an annular flange between the external threads and a pipe connection portion at a rear end.

In one embodiment of the connector assembly according to the disclosure, the internal threads and the external threads are single-start or double-start threads.

In one embodiment of the connector assembly according to the disclosure, the connector assembly further comprises a sealing ring, and the ring of the female connector comprises an annular protrusion extending radially outwards from an outer circumference thereof, and the sealing ring comprises an annular recess, and the annular recess is adapted to receive the annular protrusion, and one side surface of the sealing ring abuts or is pressed against a thin plate when the connector assembly is arranged on the thin plate in place.

In one embodiment of the connector assembly according to the disclosure, the female connector is made of a resilient metal material or a reinforced polymer.

In one embodiment of the connector assembly according to the disclosure, the male connector further comprises an operating portion extending rearwardly from the annular flange in axial direction.

In one embodiment of the connector assembly according to the disclosure, by rotating the male connector in a first direction relative to the female connector, the male connector can be moved relative to the female connector from the pre-mounting state to the mounted state; and by rotating the male connector in a second direction opposite to the first direction relative to the female connector, the male connector can be moved relative to the female connector from the mounted state to the pre-mounting state.

In another aspect of the disclosure, there is provided a method of using the connector assembly according to the disclosure, wherein the method comprises the steps of: inserting a female connector into the circular hole of the thin plate; pushing a male connector into the female connector until the connector assembly is in a mounted state in which the resilient jaws are spread radially outwards at the supporting portions by the external threads.

In a further aspect of the disclosure, there is provided a method of using the connector assembly according to the disclosure, wherein the method comprises the steps of: providing the connector assembly, wherein the male connector is assembled with respect to the female connector in a pre-mounting state in which the internal threads and the external threads are at least partially engaged with each other; inserting the connector assembly in the pre-mounting state into a circular hole of a thin plate; and rotating the male connector in a first direction relative to the female connector until the connector assembly is in a mounted state in which the resilient jaws are spread radially outwards at the supporting portions by the external threads.

In one embodiment of the method according to the disclosure, the method further comprises: rotating the male connector in a second direction opposite to the first direction relative to the female connector, such that the male connector is movable relative to the female connector from the mounted state to the pre-mounting state.

The above summary is not intended to represent each embodiment, or every aspect, of the present disclosure. Rather, the foregoing summary merely provides an exemplification of some of the novel concepts and features set forth herein. The above features and advantages, and other features and attendant advantages of the present disclosure will be readily apparent from the following detailed description of the illustrative examples and representative modes for carrying out the present disclosure when taken in connection with the accompanying drawings and appended claims. Moreover, the present disclosure expressly encompasses any and all combinations and subcombinations of the elements and features as set forth above and below.

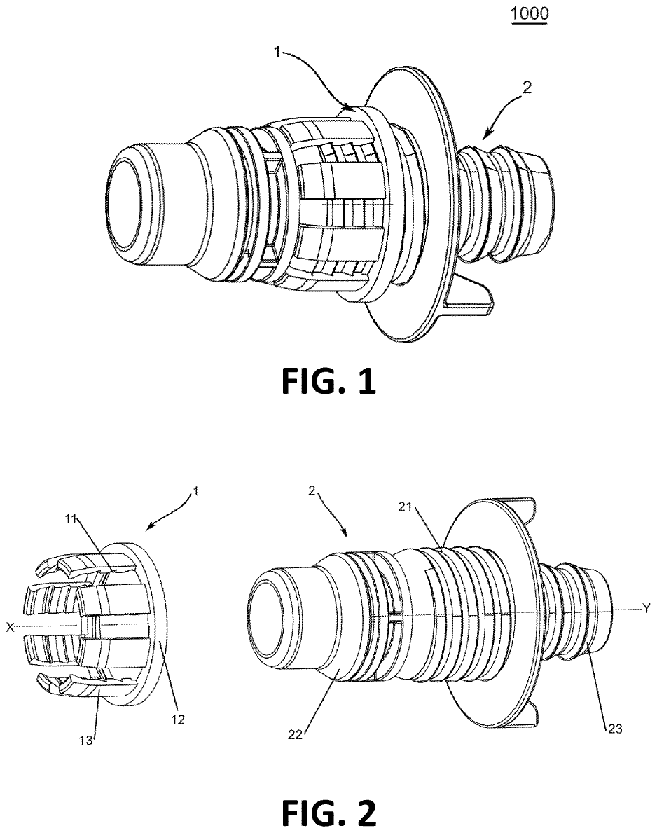

Referring now to the drawings, FIG. 1 is a perspective view of a detachable connector assembly 1000 according to one embodiment of the present disclosure, wherein the connector assembly is in a pre-mounting state. In one embodiment of the disclosure, the connector assembly 1000 is configured to be removably secured to a component such as a sheet metal component of an automotive vehicle. For example, a sheet metal part of an automotive vehicle is provided with a circular hole to which the connector assembly 1000 is removably secured, so as to pass through the sheet metal part for connecting conduits or pipes, such as a liquid conduit. Of course, the connector assembly 1000 of the present disclosure is not limited to usage on sheet metal parts, but it can also be used to secure to parts such as thin plates, and the like.

FIG. 2 is an exploded perspective view of a detachable connector assembly 1000 according to one embodiment of the present disclosure. In one embodiment of the present disclosure, the connector assembly 1000 includes a female connector 1 and a male connector 2. In one embodiment of the present disclosure, the female connector 1 and the male connector 2 are each of a hollow structure, as shown in FIG. 2. The female connector 1 is provided with internal threads 11, and the male connector 2 is provided with external threads 21, and the female connector 1 and the male connector 2 are detachably connected together by means of the internal threads 11 and the external threads 21. Preferably, the female connector 1 can be connected to and disconnected from the male connector 2 by rotating relative to each other without using a tool, as will be described below.

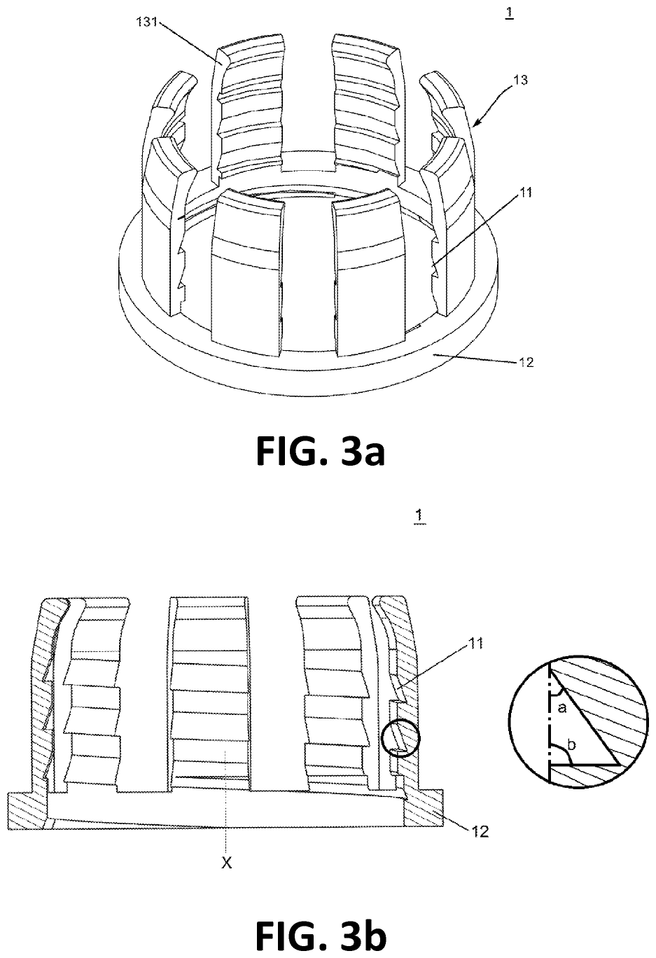

FIG. 3a is a perspective view of the female connector 1 of the detachable connector assembly 1000 according to one embodiment of the present disclosure. FIG. 3b is a cross-sectional view of the female connector of the detachable connector assembly according to one embodiment of the present disclosure as shown in FIG. 3a. In one embodiment of the disclosure, the female connector 1 is an one-piece structure which is integrally formed, and the female connector 1 has a central axis X. In one embodiment of the disclosure, the female connector 1 is a hollow structure, and said female connector 1 comprises a ring 12. In one embodiment of the disclosure, the ring 12 has an inner diameter and an outer diameter in a plane perpendicular to the central axis X, wherein the inner diameter is smaller than the diameter of the circular hole of the thin plate and the outer diameter is larger than the diameter of the circular hole of the thin plate. When the female connector 1 is inserted into the circular hole (not shown) of the thin plate from one side, the female connector 1 is stopped by the thin plate by means of the ring 12. In one embodiment of the disclosure, female connector 1 further comprises resilient jaws 13 distributed along the circumferential direction, and said resilient jaws 13 extend in the axial direction from said ring 12. In one embodiment of the disclosure, the outer circumferential surfaces of the resilient jaws 13 are parallel to the central axis X. In the embodiment of the disclosure as shown in FIGS. 1-3a, the female connector 1 comprises eight resilient jaws 13 evenly distributed in the circumferential direction. It will be appreciated by those skilled in the art that the female connector 1 may comprise a larger or smaller number of resilient jaws 13. Preferably, said female connector 1 can comprise an even number of resilient jaws 13 arranged diametrically opposite on the ring 12. In the embodiment as shown in FIG. 7, for example, the female connector 1 comprises two resilient jaws 13 arranged diametrically opposite each other.

As shown in FIG. 3a, the female connector 1 includes internal threads 11 on the inner circumferential surfaces of the resilient jaws 13. In one embodiment of the disclosure, the female connector 1 comprises at least two turns of internal threads 11 in the axial direction. In one embodiment of the disclosure, the resilient jaws 13 are integrally formed with the ring 12 at one end. The inner circumferential surfaces of the resilient jaws 13 arranged in the circumferential direction are continuous with the inner circumferential surface of the ring 12, and the outer circumferential surfaces of the resilient jaws 13 arranged in the circumferential direction are located radially inside the outer circumferential surface of the ring 12. The outer circumferential surfaces of the resilient jaws 13 arranged in the circumferential direction in a plane perpendicular to the central axis X are located between the inner diameter and the outer diameter of the ring 12. In one embodiment of the disclosure, the resilient jaws 13 are substantially identical in shape, with only a slight difference in the positions of the internal threads 11. In one embodiment of the present disclosure, each resilient jaw 13 is terminated with a free end 131, also called a supporting portion 131. In one embodiment of the present disclosure, the supporting portion 131 has an axial length larger than that of one thread groove, and the inner peripheral side of the supporting portion 131 protrudes further radially inward toward the central axis X than the internal threads 11 so that the resilient jaws 13 can be radially spread apart or enlarged at the supporting portion 131 by the external threads 21 of the male connector 2. In one embodiment of the present disclosure, The female connector 1 is preferably made of a material having excellent mechanical properties and heat resistance, such as glass fiber reinforced nylon, the tensile strength of which can be up to 260 MPa, the bending strength of which can be 360 MPa, or carbon fiber reinforced polyetheretherketone, the tensile strength of which can be doubled at room temperature and tripled at 150 °C. Thus, the connector assembly according to the present disclosure is able to maintain good stability under high temperature and harsh environmental conditions.

FIG. 3b is a cross-sectional view of the female connector 1 of the detachable connector assembly 1000 according to one embodiment of the disclosure as shown in FIG. 3a, with the geometry of the threads 11 being illustrated in an enlarged manner. As will be readily understood by a person skilled in the art, the external thread 21 of the male connector 2 has a shape complementary to the thread 11. In FIG. 3b, a cross-section of the thread 11 is schematically shown. In one embodiment of the disclosure, the cross-section of the thread 11 is triangular as shown in FIG. 3b. In one embodiment of the disclosure, the bottom surface of the thread 11 forms an angle b with the central axis X, said angle b being between about 90 and 105 degrees, preferably of about 90 degrees. In one embodiment of the disclosure, the slope of the thread 11 forms an angle a with the central axis X, said angle a being a small acute angle, for example said angle a being less than 30 degrees, preferably between 15 and 25 degrees. In conventional thread designs, triangular threads are the most widely used type of thread, with a triangular cross-section, and the common types of triangular thread profile angles are 60 degrees and 55 degrees. That is, in conventional triangular threads, angle b is typically an acute angle, preferably 60 degrees or 62.5 degrees. In the embodiment of the present disclosure, the thread 11 is a special thread different from a conventional triangular thread, and the thread 11 has a cross section with a substantially right angle b, and the bottom surface of the thread 11 can bear a relatively large axial force, and thus a good blocking effect is achieved.

In one embodiment of the disclosure, the female connector 1 has at least two turns of internal threads 11. Preferably, the female connector 1 has three turns of internal threads 11 to ensure the stability and reliability of the connection. In one embodiment of the disclosure, the male connector 2 has external threads 21, and the number of turns of the external threads 21 is at least one more turn, preferably two or three more turns, than the number of turns of the internal threads 11, so as to provide sufficient connection strength and sealing performance for the connector assembly. In one embodiment of the disclosure, the internal threads 11 and the external threads 21 are single-start threads. In another embodiment of the disclosure, the internal threads 11 and the external threads 21 are double-start threads. The double-start threads facilitates a quick movement of the male connector 2 relative to the female connector 1.

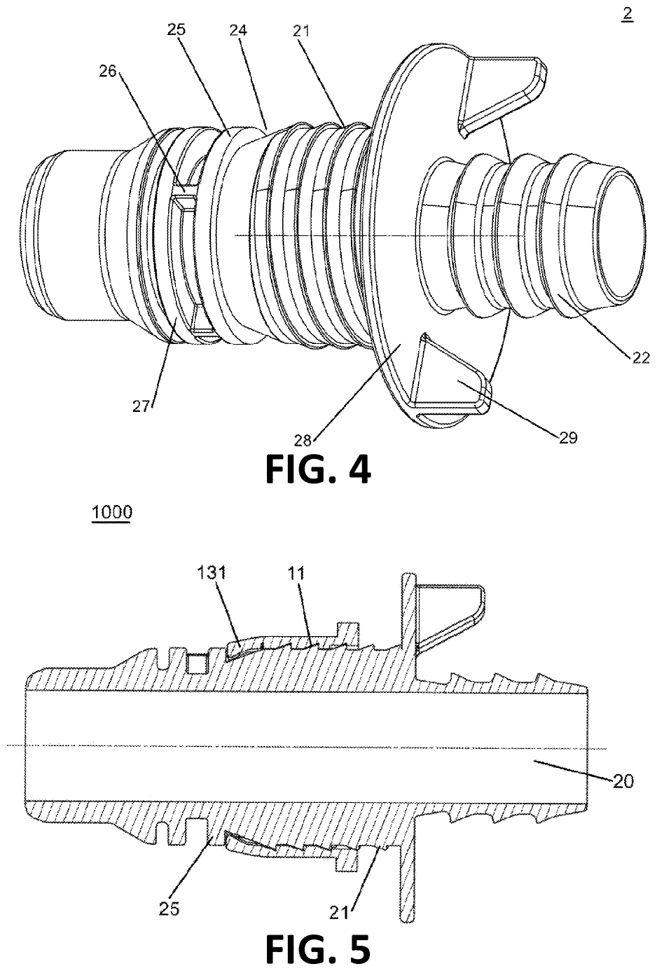

FIG. 4 is a perspective view of the male connector 2 of the detachable connector assembly 1000 according to one embodiment of the present disclosure. FIG. 5 is a cross-sectional view of the detachable connector assembly 1000 according to one embodiment of the present disclosure as shown in FIG. 1, wherein the connector assembly 1000 is in a pre-mounting state.

In one embodiment of the present disclosure, the male connector 2 is an an one-piece structure which is integrally formed, and the male connector 2 has a central axis Y. When the female connector 1 is connected to the male connector 2, the central axis X of the female connector 1 coincides with the central axis Y of the male connector 2. In one embodiment of the present disclosure, the male connector 2 is a hollow structure provided with a first pipe connecting part 22 at a front end and a second pipe connecting part 23 at a rear end, and the first pipe connecting part 22 and the second pipe connecting part 23 are used to connect to different pipes respectively, as will be readily understood by those skilled in the art. Thereby, the male connector 2 functions as a pipe connector to connect to different pipes from the front end and the rear end, respectively. As shown in FIG. 5, the male connector 2 includes an internal passage 20, and the internal passage 20 extends from a first pipe connecting part 22 to a second pipe connecting part 23, for example for fluid transfer, such as liquid.

In one embodiment of the disclosure, the male connector 2 comprises external threads 21 in the middle, and said external threads 21 are adapted to engage with the internal threads 11 of the female connector 1 to facilitate the detachable connection of said connector assembly 1000. In one embodiment of the present disclosure, at a position near the front end of the external thread 21, a supporting portion receiving groove 24 is provided, and the supporting portion receiving groove 24 is used for receiving a supporting portion 131 of the female connector 1. In one embodiment of the present disclosure, the supporting portion receiving groove 24 is recessed deeper than the external threads 21 so that when the female connector 1 is pre-mounted on the male connector 2 in a pre-mounting state, the supporting portion 131 can be received in the supporting portion receiving groove 24 and the resilient jaw 13 is tightly attached onto the male connector 2, and an outer circumferential surface which is formed by the supporting portion 131 of the resilient jaw 13 is not larger than an outer circumferential surface of one end of the resilient jaw 13 which is connected to the ring 12. That is, when the female connector 1 is pre-mounted on the male connector 2 in a pre-mounting state, the resilient jaws 13 are tightly attached onto the male connector 2, and the resilient jaws 13 are not spread or expanded at the supporting portions 131, so that the connector assembly 1000 thus pre-mounted can be inserted together into a circular hole of a thin plate, thereby facilitating quick completion of an assembly process.

In one embodiment of the present disclosure, the male connector 2 is provided with a first annular projection 25 in front of the supporting portion receiving groove 24, and when the female connector 1 is pre-mounted on the male connector 2 in a pre-mounting state, the foremost end of the supporting portion 131 of the resilient jaw 13 substantially contacts the first annular projection 25, so that the male connector 2 can no longer be axially moved forward by being rotated or pushed relative to the female connector 1. In one embodiment of the disclosure, the male connector 2 is optionally provided with a second annular projection 27, the second annular projection 27 being located in front of the first annular projection 25. Preferably, one or more axially extending support ribs 26 are provided between the first annular projection 25 and the second annular projection 27 for reinforcing the strength of the first annular projection 25.

In one embodiment of the present disclosure, the male connector 2 is provided with an annular flange 28 between the external thread 21 and the second pipe connecting part 23, and the annular flange 28 has a maximum outer diameter which is larger, preferably significantly larger, than the maximum outer diameter of the ring 12 of the female connector 1. In one embodiment of the present disclosure, the male connector 2 further includes an operating portion 29 extending rearward from the annular flange 28. In one embodiment of the disclosure, the operating portion 29 is a tab 29 extending rearward from the annular flange 28 in the direction of the central axis Y. In one embodiment of the disclosure, the male connector 2 comprises two opposite tabs 29 extending along a diameter of the annular flange 28.

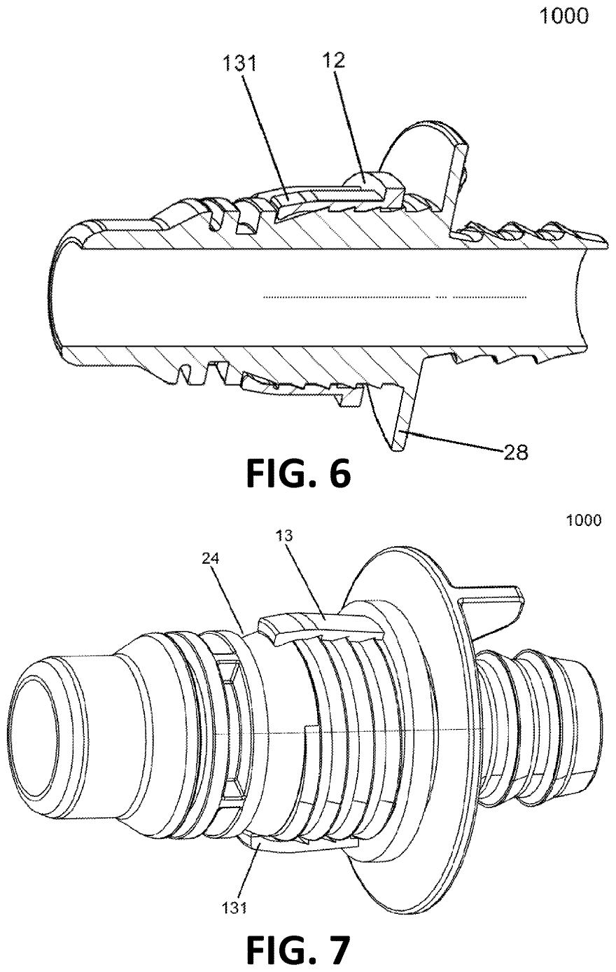

FIG. 6 is a cut-away perspective view of the detachable connector assembly 1000 according to one embodiment of the present disclosure as shown in FIG. 1, wherein the connector assembly 1000 is in a pre-mounting state. When it is necessary to tighten the male connector 2 to the female connector 1 up to a pre-mounting state, a user can apply a tightening force on the tab 29 so that the male connector 2 moves forward with respect to the female connector 1 by rotating the male connector 2 along the direction of thread rotation, and the tab 29 contributes to improving the operability of the connector assembly 1000. When it is necessary to tighten the male connector 2 with respect to the female connector 1 from a pre-mounting state to a mounted state, the user can apply a tightening force on the tab 29 so that the male connector 2 is further moved forward with respect to the female connector 1. Likewise, when the connector assembly 1000 needs to be detached from a thin plate, for example, when maintenance or inspection is required, a user can apply a tightening force on the tab 29 in an opposite direction so that the male connector 2 is moved rearward relative to the female connector 1, thereby tightening the male connector 2 from a mounted state to a pre-mounting state relative to the female connector 1, and thus the connector assembly 1000 can be released from the thin plate, as will be described later. It will be readily apparent to those skilled in the art that, other structures than the tab 29 may be employed to enhance the rotational operability of the male connector 2 with respect to the female connector 1. In one embodiment of the present disclosure, by rotating the male connector 2 in a first direction (e.g., clockwise) with respect to the female connector 1, the male connector 2 can be moved from the pre-mounting state to the mounted state with respect to the female connector 1, thereby completing the mounting of the connector assembly 1000. By rotating the male connector 2 in a second direction (for example, counterclockwise) opposite to the first direction with respect to the female connector 1, the male connector 2 can be moved from the mounted state to the pre-mounting state with respect to the female connector 1, so that the connector assembly 1000 can be detached from the thin plate.

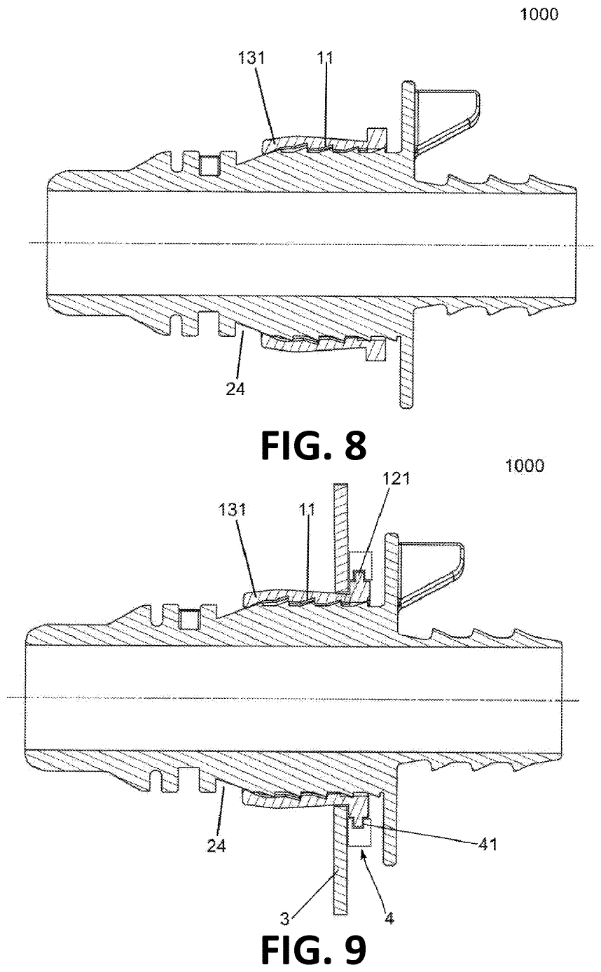

FIG. 7 is a perspective view of a detachable connector assembly 1000 according to another embodiment of the present disclosure, wherein the connector assembly 1000 is in a mounted state. FIG. 8 is a cross-sectional view of a detachable connector assembly 1000 according to another embodiment of the present disclosure, wherein the connector assembly 1000 is in a mounted state. In FIG. 7, the female connector 1 comprises two resilient jaws 13 arranged opposite each other. As shown in the cross-sectional view of FIG. 8, the supporting portion 131 of the resilient jaw 13 leaves the supporting portion receiving groove 24 of the male connector 2, and the external threads 21 of the male connector 2 spread the resilient jaw 13 outwards, so that the resilient jaw 13 radially expands or spreads outward, and the resilient jaw 13 is tightly attached to a thin plate or a sheet metal part.

In one embodiment of the present disclosure, there is also disclosed a method of mounting the connector assembly 1000 to a thin plate. First, the female connector 1 is inserted into the circular hole of the thin plate. Then, the male connector 2 is forcibly pushed into the female connector 1 from one end of the female connector 1 near the ring 12, for example, by means of an axial force, until the connector assembly 1000 is in a mounted state in which the resilient jaws 13 are spread radially outward at the supporting portions 131 by the external threads 21. In this way, the connector assembly 1000 is very quickly mounted into position on the thin plate by means of the axial force, increasing the efficiency of the assembly process and reducing costs. Of course, it is also possible to firstly push the male connector 2 into the female connector 1 from one end of the female connector 1 near the ring 12 by means of an axial force to a pre-mounting state, then insert the connector assembly 1000 in the pre-mounting state together into a circular hole of a thin plate, and then rotating the male connector 2 relative to the female connector 1 until the connector assembly 1000 is in a mounted state in which the resilient jaws 13 are spread radially outward at the supporting portions 131 by the external threads 21.

FIG. 9 is a schematic cross-sectional view of a detachable connector assembly 1000 according to yet another embodiment of the present disclosure, wherein the connector assembly 1000 is in a mounted state, and the connector assembly 1000 further comprises a sealing ring 4. In this embodiment of the disclosure, the ring 12 of the female connector 1 includes an annular protrusion 121 extending radially outward from the outer circumferential surface thereof. The sealing ring 4 comprises an annular recess 41, and the annular recess 41 is adapted to receive the annular protrusion 121, whereby the sealing ring 4 can be arranged on the ring 12 of the female connector 1. When the connector assembly 1000 is arranged in place on the thin plate 3, one side surface of the sealing ring 4 is in close contact or pressed firmly against the thin plate 3, ensuring by friction that the female connector 1 does not move or rotate relative to the thin plate 3. In addition, in this mounted state, the supporting portions 131 of the resilient jaws 13 leave the supporting portion receiving groove 24 of the male connector 2, and the external threads 21 of the male connector 2 spreads the resilient jaws 13 outwards, causing the resilient jaws 13 to expand radially, and the resilient jaws 13 are tightly attached to the thin plate or the sheet metal part.

By adopting the connector assembly according to the disclosure, the female connector and the male connector of the connector assembly can be repeatedly mounted and dismounted, and preferably the connector assembly can be dismounted without using tools, so that the capability of repeatedly dismounting and mounting the connector assembly from a sheet metal part or a thin plate is improved, and the cost for a user is reduced, and the production efficiency is improved.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited, because other modifications will become apparent upon a study of the drawings, the specification, and the following claims. For example, unless specifically stated otherwise, the size, shape, location or orientation of the various components may be changed as needed and/or desired, provided such changes do not substantially affect their intended functions. Unless otherwise specifically stated, components shown as directly connected or contacting each other may have intermediate structures disposed between them so long as the changes do not substantially affect their intended functions. The functions of one element may be performed by two elements, and vice versa, unless specifically stated otherwise. The structure and function in one embodiment may be adopted in another embodiment. Not all advantages must be present in a particular embodiment at the same time. Each feature which is unique from the prior art, alone or in combination with other features, also should be considered a separate description of further disclosures by the applicant, including the structural and/or functional concepts embodied by such features. It should be understood that one or more steps within a method may be performed in a different order (or simultaneously) without altering the principles of the present disclosure. Moreover, although each of the embodiments is described above as having certain features, any one or more of those features described with reference to any embodiment of the disclosure may be implemented in and/or combined with the features of any of the other embodiments, even if the combination is not explicitly described. In other words, the described embodiments are not mutually exclusive and replacements and combinations of one or more embodiments with each other are still within the scope of the present disclosure.

What is claimed is:

1. A connector assembly (1000) comprising:
a female connector (1) and a male connector (2), wherein the female connector (1) and the male connector (2) are both of a hollow structure, and wherein the female connector (1) comprises a ring (12) and resilient jaws (13) extending from the ring (12) in an axial direction, the resilient jaws (13) being distributed on the ring (12) in a circumferential direction, wherein internal threads (11) are arranged on the resilient jaws (13), and wherein the male connector (2) is provided with external threads (21) for threaded engagement with the internal threads (11), and wherein the resilient jaws (13) have supporting portions (131) at free ends thereof, and wherein inner peripheral sides of the supporting portions (131) protrude further radially inward than the internal threads (11).

2. The connector assembly (1000) of claim 1, wherein the female connector (1) is a one-piece structure which is integrally formed, and wherein the female connector (1) has a central axis (X), and wherein the male connector (2) is movable by rotation relative to the female connector (1) between a pre-mounting state, in which the internal threads (11) are at least partially engaged with the external threads (21), and a mounted state, in which the resilient jaws (13) are spread radially outward at the supporting portions (131) by the external threads (21).

3. The connector assembly (1000) of claim 2, wherein the female connector (1) has the internal thread (11) with a triangular cross-section, and wherein a bottom surface of the internal thread (11) forms an angle (b) with the central axis (X), the angle (b) being about 90 degrees, and wherein a slope of the internal thread (11) forms an angle (a) with the central axis (X), the angle (a) being less than 30 degrees.

4. The connector assembly (1000) of claim 2, wherein the resilient jaws (13) are evenly distributed in a circumferential direction.

5. The connector assembly (1000) of claim 2, wherein the female connector (1) comprises an even number of resilient jaws (13) arranged diametrically opposite on the ring (12).

6. The connector assembly (1000) of claim 1, wherein the internal threads (11) of the female connector (1) are located on an inner circumferential surface of the resilient jaws (13), and wherein the female connector (1) comprises at least two turns of the internal threads (11), and wherein a number of turns of the external threads (21) is at least one turn greater than a number of turns of the internal threads (11).

7. The connector assembly (1000) of claim 3, wherein the resilient jaws (13) are integrally formed with the ring (12) at one end, and wherein inner circumferential surfaces of the resilient jaws (13) are continuous from an inner circumferential surface of the ring (12), and wherein outer circumferential surfaces of the resilient jaws (13) are located radially inward of an outer circumferential surface of the ring (12).

8. The connector assembly (1000) of claim 1, wherein the supporting portions (131) have an axial length which is greater than an axial length of one thread groove of the external threads (21).

9. The connector assembly (1000) of claim 1, wherein the male connector (2) is a one-piece structure which is integrally formed, and wherein two ends of the male connector (2) are each provided with a pipe connection portion respectively, and wherein the male connector (2) comprises an internal passage (20), and wherein the internal passage (20) extends axially through the pipe connection portions.

10. The connector assembly (1000) of claim 8, wherein at a position near a front end of the external thread (21) of the male connector (2), a supporting portion receiving groove (24) is provided, the supporting portion receiving groove (24) being recessed deeper than the external threads (21), and wherein the supporting portions (131) are able to be received in the supporting portion receiving groove (24) when the female connector (1) is pre-mounted on the male connector (2) in a pre-mounting state, and wherein the supporting portions (131) are spread radially outward by the external threads (21) when in a mounted state.

11. The connector assembly (1000) of claim 10, wherein the male connector (2) is provided with a first annular projection (25) in front of the supporting portion receiving groove (24), and wherein foremost ends of the supporting portions (131) of the resilient jaws (13) substantially contact the first annular projection (25) when the female connector (1) is pre-mounted on the male connector (2) in a pre-mounting state.

12. The connector assembly (1000) of claim 1, wherein the male connector (2) is provided with an annular flange (28) between the external threads (21) and a pipe connection portion at a rear end.

13. The connector assembly (1000) of claim 1, wherein the internal threads (11) and the external threads (21) are single-start or double-start threads.

14. The connector assembly (1000) of claim 3, wherein the connector assembly (1000) further comprises a sealing ring (4), and wherein the ring (12) of the female connector (1) comprises an annular protrusion (121) extending radially outward from an outer circumference thereof, and wherein the sealing ring (4) comprises an annular recess (41), the annular recess (41) being adapted to receive the annular protrusion (121), and wherein one side surface of the sealing ring (4) abuts or is pressed against a thin plate when the connector assembly (1000) is arranged on the thin plate in place.

15. The connector assembly (1000) of claim 1, wherein the female connector (1) is made of a resilient metal material or a reinforced polymer.

16. The connector assembly (1000) of claim 1, wherein the male connector (2) further comprises an operating portion (29) extending rearwardly from an annular flange (28) in an axial direction.

17. The connector assembly (1000) of claim 2, wherein:
by rotating the male connector (2) in a first direction relative to the female connector (1), the male connector (2) can be moved relative to the female connector (1) from the pre-mounting state to the mounted state; and
by rotating the male connector (2) in a second direction opposite to the first direction relative to the female connector (1), the male connector (2) can be moved relative to the female connector (1) from the mounted state to the pre-mounting state.

18. A method of using the connector assembly (1000) of claim 1, the method comprising:
inserting the female connector (1) into a circular hole of a thin plate; and
pushing the male connector (2) into the female connector (1) until the connector assembly (1000) is in a mounted state in which the resilient jaws (13) are spread radially outward at the supporting portions (131) by the external threads (21).

19. A method of using the connector assembly (1000) of claim 1, the method comprising:
providing the connector assembly (1000), wherein the male connector (2) is assembled with respect to the female connector (1) in a pre-mounting state in which the internal threads (11) and the external threads (21) are at least partially engaged with each other;
inserting the connector assembly (1000) in the pre-mounting state into a circular hole of a thin plate; and
rotating the male connector (2) in a first direction relative to the female connector (1) until the connector assembly (1000) is in a mounted state in which the resilient jaws (13) are spread radially outward at the supporting portions (131) by the external threads (21).

20. The method of claim 18, further comprising:
rotating the male connector (2) in a second direction opposite to the first direction relative to the female connector (1), such that the male connector (2) is movable relative to the female connector (1) from the mounted state to the pre-mounting state.
